(19) United States
(12) Patent Application Publication
(10) Pub. No.: US 2009/0005167 A1
(43) Pub. Date: Jan. 1, 2009

(54) Mobile Gaming with External Devices in Single and Multiplayer Games

(76) Inventors: Juha Arrasvuori, Tampere (FI); Mikko Hurskainen, Espoo (FI); Ville Kankainen, Siuro (FI); Kari Laurila, Tampere (FI); Ville-Veikko Mattila, Tampere (FI); Juha Kaario, Tampere (FI)

Correspondence Address: PERMAN & GREEN, 425 POST ROAD, FAIRFIELD, CT, 06824, US

(21) Appl. No.: 11/720,209

(22) PCT Filed: Nov. 29, 2004
(86) PCT No.: PCT/EP2004/013523

§ 371 Date: Sep. 5, 2008

(51) Int. Cl. A63F 9/24; H04M 1/00

(52) U.S. Cl. 463/40; 455/556.1

(57) ABSTRACT

Methods, systems and apparatuses for gaming using one or more mobile communication devices and one or more remotely-controllable drones, the one or more mobile communication devices being adapted to remotely-control the one or more remotely-controllable drones; including providing game control software to one or more of the mobile communication devices, the game control software including rules for play affecting the operation of the remotely-controllable drones; and, operating a remotely-controllable drone using the mobile communication device with remote control within the rules of play of the game.

This application is the National Stage of International Application No. PCT/EP2004/013523, International Filing Date, Nov. 29, 2004 which designated the United States of America, and which international application was published under PCT Article 21(2) as WO Publication No. WO 2006/056231.

### FIELD

This invention relates to wireless electronic games, particularly, interactive games with one or more players using mobile telephones and external, peripheral devices.

### BACKGROUND

Personal communication apparatuses in the form of mobile or cellular telephones have become extremely popular and are in widespread use throughout the world. Moreover, mobile telephones have evolved from just portable analogues of traditional fixed-line telephones, no longer providing only voice communication, rather now having been developed into multi-faceted communication devices providing a large range of communication options including notably wide area network, e.g., internet, access as well as near field gaming intercommunications.

Furthermore, electronic games have become a major part of the entertainment industry in the modern world. The playing of electronic games on stand-alone terminals such as mobile telephones has long been popular. However, in recent years these games have migrated into a network environment. Indeed, electronic games are also now operative in the context of mobile gaming. Mobile gaming is a term used to refer to all aspects of electronic games in the context of mobile communications, i.e., using one or more mobile telephone units or like communications devices.

Currently, it is very common for portable communication devices such as mobile phones or terminals to have, preloaded on/in a memory of the phone, content relating to one or more electronic games that can be played on the mobile phone through the phone's User Interface (UI) usually involving a display and keys. Such pre-stored games may be accessed via navigation through the phone's various menu options for selection of the particular electronic game to be played. Certain keys of the mobile phone's keypad may be assigned control functionality for controlling certain predetermined features of the game in relation to other features of the game which may often be under the control of the software of the game. In this way, a user can play ‘against the computer.’

Additionally and/or alternatively, interactive multiplayer, i.e., two or more player, games have also become available for use in mobile phone communication environments, with each player having a mobile phone in communication with one or more other mobile phones. In this way, the phones can communicate information about a game back and forth, each user or player using controls (e.g., assigned keys, buttons, joysticks or the like) on each of their respective phone units to control each of their particular game piece(s) or character(s) with which he/she plays against the other player(s), the phone units communicating respective player data entry, such as moves, to each of the other mobile phone units, thus constantly updating the state of the game for the benefit of all users/players. Examples of such multi-player, mobile gaming systems are described in the Nokia Corp. patent application publication WO2004011114 and U.S. Pat. No. 6,579,184, inter alia.

Moreover, mobile telephone units have, in a discreet environment, also now been made useful as remote control units. As an example, the Sony-Ericsson company now offers a Bluetooth-controlled toy car controllable by a mobile telephone unit. The Sony-Ericsson published patent application, WO98049818, describes a system enabling a mobile phone to provide combined mobile telephony and remote control terminal functionalities, particularly in one example, describing a mobile station (i.e., a mobile phone) which includes functionalities enabling the mobile station to communicate with a Public Land Mobile Network (PLMN) as well as providing command and communication (e.g., local communications) functionalities to remotely control one or more of a variety of peripheral devices through user-provided inputs into the mobile phone.

As a final background point, radio frequency identification, also known as RFID, techniques and systems are also known for communicating information to and/or connecting mobile phones to networks such as the internet. In particular, RFID tags as input to games is known, as for example is described in the Nokia Corp. patent application publication WO2004003829. As such, an RF tag may be located in a casing of a size to facilitate handling by the user, wherein the RF tag stores code and/or data regarding a game character and/or code to direct the operation of a game and/or of a user's personal communication apparatus. The user's personal communication apparatus has an RF tag reader which is operable upon reading the RF tag to perform an operation associated with said RF tag. Thus by maneuvering the device such that the RF tag is read by the RF tag reader, the personal communication apparatus can then be updated with the new data and/or perform an operation associated with the RF tag offering rapid access to data and/or regularly used functions or operations. Also, the device can be used to selectively enable/disable local functions of a user's personal communication apparatus. An interaction of the RF tag with the user's personal communication apparatus can generate an action code from external of the user's personal communication apparatus; automatically routing an action-request message, including an action code field which is the same as or derived from said action code, to a server; and the server performing instructions to further the performance of the desired operation.

### SUMMARY

According to a first aspect there is provided a method of or system for gaming played on one or a plurality of mobile communications devices together with one or more remotely-controllable drones. According to this aspect of the invention a wireless communications method includes providing game control software to a mobile communication device, the game control software including rules for play affecting the operation of the remotely-controllable drone; and, operating the remotely-controllable drone using the mobile communication device with remote control within the rules of play of the game.

In such a method or system one or more players in a single or multi-player gaming environment may each use their own respective mobile communications devices with one or more remotely-controllable drones. A single player may control a single drone, and/or each of several players may control each of their own respective drones. Alternatively, multiple players can control one drone, as for example when two or more player may each be involved in controlling a single drone, or control messages of one player can affect several drones.

Currently multiplayer games are limited to what happens inside computer or mobile device only, such as what may be displayable only on the mobile device display area or screen. The current solution would make it possible to extend the games beyond the mobile device display area using external, peripheral devices. Advantages thus include extending mobile game playing outside the mobile communication devices for controlling one or more remote controllable devices in a gaming environment.

According to another aspect, methods and/or systems hereof include using phone software and close domain radio network to create a multiplayer game environment for external devices with sensors and/or affecting game parameters with separate programmed or programmable data communication devices such as Bluetooth or RFID cards. Moreover, some environmental objects in a game may be adapted to be affected or controlled by one or more of the players. These features allow simulation of real life environments.

External, peripheral devices could be used to enrich the multi-playing experience. By altering the remote controllable device's behavior, based, for example, on detecting what is happening in the game environment with sensors, it is possible to simulate real life situations. Game examples include, inter alia, races and obstacle courses for automobile types of drones, combat situations for military craft and/or robot types of drones as well as the creation of a user's own environments and/or drones of virtually any type using, in one example, toy building blocks.

### BRIEF DESCRIPTION OF THE DRAWINGS

For a better understanding of the disclosed embodiments and to understand how the same may be brought into effect reference will now be made, by way of example only, to the accompanying drawings, in which:

FIG. 1 provides isometric illustration of a first embodiment of a hand portable phone or personal communication terminal according to an aspect of the invention.

FIG. 2 schematically shows parts of a hand portable phone for communication with a cellular network and/or multi-player gaming, for example.

FIG. 3, which includes the sub-part FIGS. 3A and 3B, schematically shows network intercommunications of a plurality of phones in multi-player gaming.

FIG. 4 schematically shows a network of intercommunications between a plurality of phones and respective drones for use in multi-player gaming according hereto.

FIG. 5 schematically shows an alternative network of intercommunications between a plurality of phones and respective drones for use in multi-player gaming according hereto.

FIG. 6 schematically shows intercommunications between a phone and a respective drone and a gaming environment for use in single or multi-player gaming according hereto.

### DETAILED DESCRIPTION

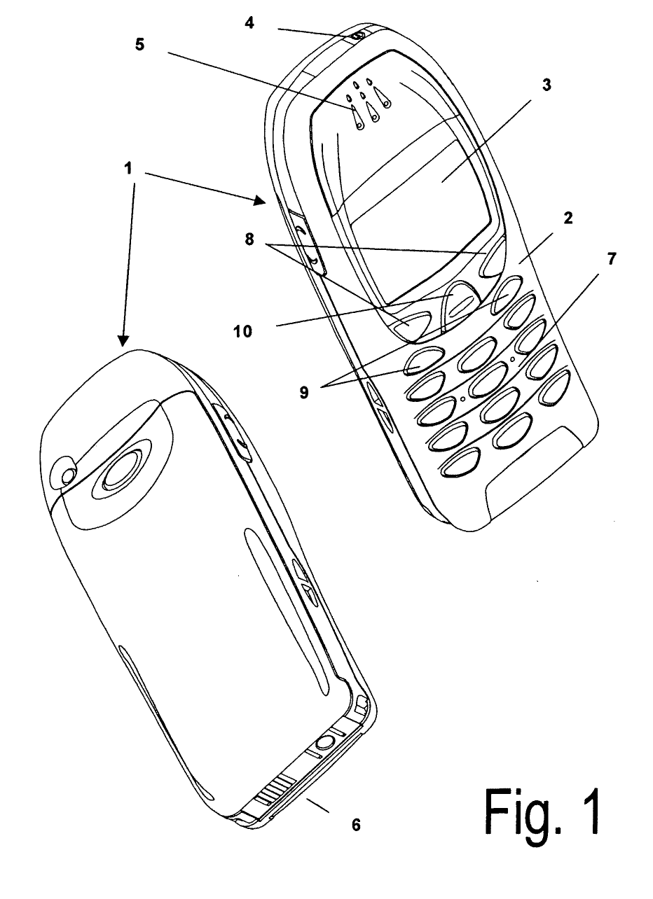

FIG. 1 shows a preferred embodiment of a portable personal communication apparatus in an exemplar form of a mobile or a cellular phone 1, hereafter also referred to as a handset or a wireless terminal 1, which may be used for standard mobile telephony as well as for multi-party gaming according to the present invention, as described in detail hereafter. The wireless terminal comprises a user interface having a keypad 2, a display 3, an on/off button 4, a speaker 5 (only structural openings are shown), and a microphone 6 (only structural openings are shown).

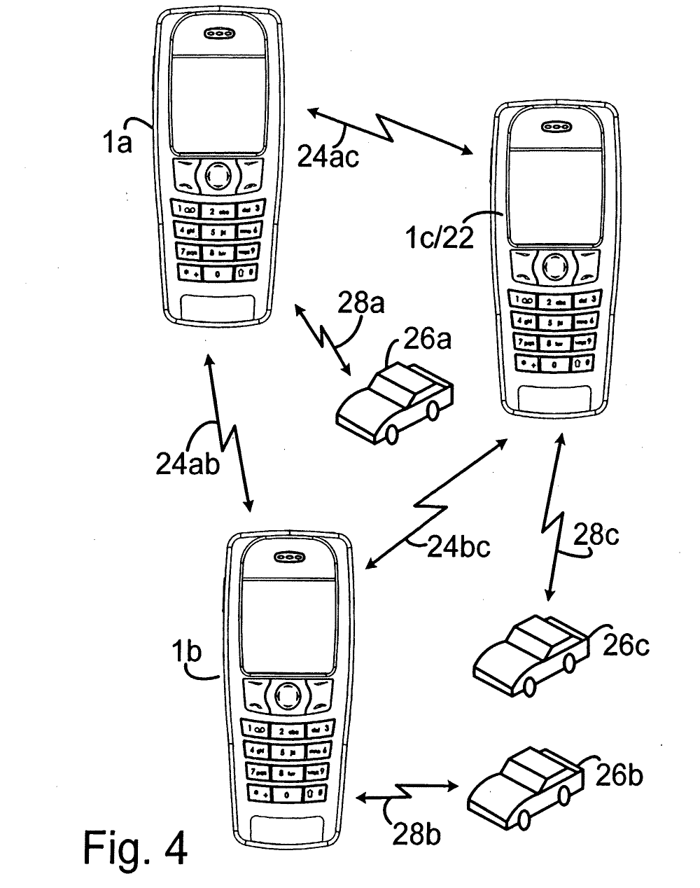

According to a first embodiment of the invention, the keypad 2 has a first group 7 of data entry buttons or keys as alphanumeric keys, two softkeys 8, and a scroll-key 10 (up/down and/or right/left and/or any combination thereof) for moving a cursor in the display. An alternative hereto may be a four-way button, an eight-way button or a joystick or a like controller (none of which being shown here, but see the four-way and/or eight-way buttons inherent in the phones 1 of FIGS. 4, 5 and 6, described below). Furthermore the keypad may include two call-handling keys 9 for initiating and terminating calls. The functionality of the softkeys 8 may be shown in a separate field in the bottom (or other area) of the display 3 just above the softkeys 8.

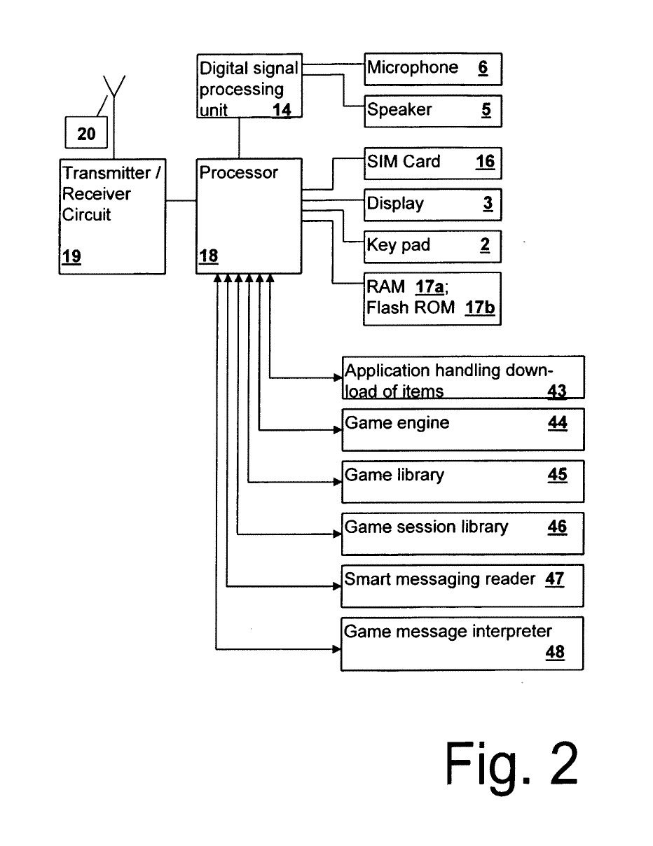

FIG. 2 schematically shows some of the more important parts of a preferred embodiment of a phone 1, said parts being related to an understanding of the invention. A processor 18, which supports the GSM terminal software, also controls the communication with a network via a transmitter/receiver circuit 19 and an antenna 20.

The microphone 6 receives the user's speech into analogue signals; the signals transmitted thereby are A/D converted in an A/D converter (not separately shown) before the speech is encoded in an audio processing part 14. The encoded speech signal is transferred to the processor 18 which then provides for the encoded speech signal to be communicated via the transmitter/receiver 19 and an antenna 20 to the network and the intended recipient. Going the other way, in receiving an encoded signal from the network via the transmitter/receiver 19, the audio part 14 speech-decodes the signal, which is transferred from the processor 18 to the speaker 5 via a D/A converter (not separately shown). The processor 18 also forms the interface to the keypad 2 and the display 3, and a SIM card 16, as well as preferably to a RAM memory 17a and a Flash ROM memory 17b, (and other possible devices for data, power supply, etc. (not separately shown)). The memory devices 17a and/or 17b may be used to store, inter alia, a phonebook, an address book, emails and SMS messages which have been sent and received, and call lists containing lists of calls made and received, and missed calls; as well as for purposes of the present invention, game information, either in the form of one or more stored game applications and/or game data related to a particular user's game piece(s), character(s) or drone(s) (see below).

A game message containing information about a game move can be transmitted over the air interface, e.g., using a game message format. Such a game message format may be included into the Nokia Smart Messaging Specification (SMS), inter alia. Implementation of such a service depends on the handset terminal capabilities. A handset 1 according to preferred embodiments of the invention may include an application 43 for handling game downloads (and/or uploads), which can participate in setting up or playing a game application, as for example, when receiving a game invitation message, updating a game session when receiving a game message, and providing a game message based on game settings entered into the game session when the user enters a game move.

The game message according to some preferred embodiments may be of a Narrow Band Specification (NBS) and may include an NBS port identification number (a predetermined hexadecimal number), as specified, for example, in the “Narrowband Sockets Specification,” revision 1.0, Mar. 7, 1997, whereby a smart messaging reader 47 is able to recognise a received message as a game message. Once a message is identified as a game message the content of the message is transferred to a game message interpreter 48 running on or in association with the processor 18. The game message interpreter 48 breaks down the game message to its individual parts identifying the game session number, the move of the game, and additional content if included.

The individual parts identified by the game message interpreter 48 are transferred to a game engine 44, which based on the game session number fetches the associated game session file from a game session library 46. The game engine 44 updates the game session file by adding the recently received game move to the list of moves already being present in the record. The game engine 44 identifies the game application from the game session file, opens the identified game application from a game library 45, enters the game moves and displays the current diagram for the game in a wireless terminal display 3 as indicated generally in FIG. 1.

The terminal display 3 may include display of a header or other indicia (not shown) notifying what current game is currently being played and who are the one, two or more players, and what is the status of each of the players and of the game itself. Preferably also displayed is an enriched game environment, including game pathways and obstacles, preferably pictorially rendered (either artistically or using recording or recorded visual depictions). Additional content may alternatively also be included in the game messages, such as a text message from one party being displayed to one or more other user(s) prior to or along with the display of the game diagram itself.

The application may further provide for displaying the other gaming party's movements of his/her particular playing piece(s) (character(s) or drone(s)), and these may be shown as animation(s) together with display of the game diagram. According to a preferred embodiment of the invention the game application provides for the user to move their playing piece(s) by highlighting or otherwise marking the corresponding piece on the user's display, which marking may be implemented by letting the animation gleam or otherwise be highlighted (this is not shown in the figures).

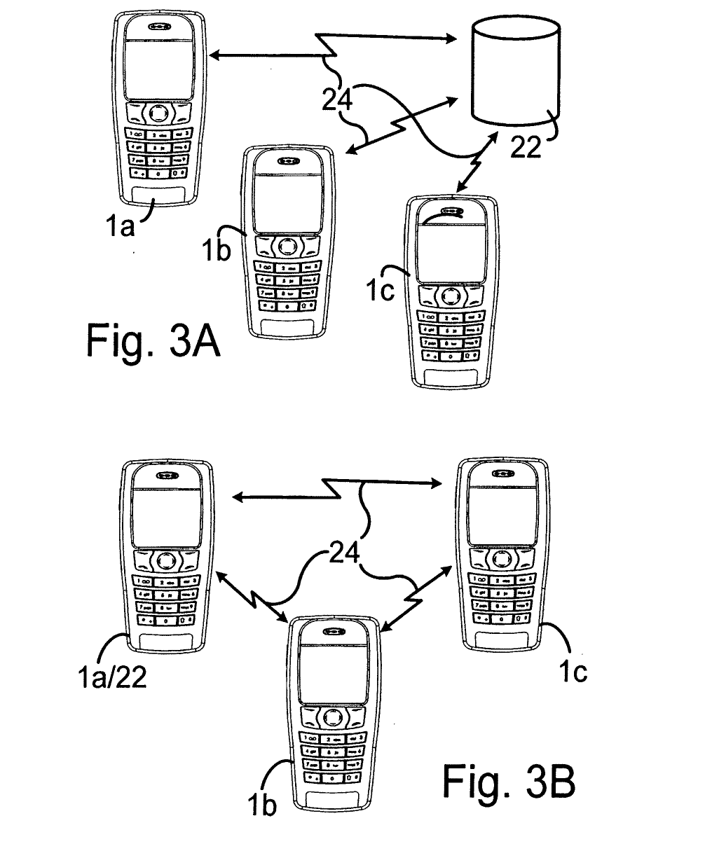

The presented usage case relates to a multi party game offered and arranged on an interconnected network. Connectivity of multiple phones 1 for multi-player gaming is possible using a number of networking structures and/or protocols. As described herein generally and as shown in FIGS. 3, 4 and 5 (see detailed descriptions hereof below); primarily these connection schemes may include/involve application level protocols, such as a game protocol, or a protocol used with drones. Although there may be others than described here, at least five (5) different ways to establish connectivity may easily be available using substantially conventional wireless phone technologies. Briefly, these include: a star topology; an ad hoc network; a limited ad hoc network; very simple radio frequency (RF) and/or Bluetooth (BT) connectivities, inter alia.

Although these will be described in further detail below, these connectivity or networking schemes may generally have a basic peer-to-peer and/or client/server structure, although a distributed server structure is another alternative. Note, in most cases, peer-to-peer will be prevalent, and a peer-to-peer application connected in an ad-hoc network (described below) is presently preferred.

The first example for connectivity described here is a star topology with one acting server, and one or more mobile phones 1 communicatively connected to the server. Although a client/server network with a star topology is a networking arrangement known well in the art, a simple form thereof is set forth in FIG. 3A which shows a conventional star topology as may be used in an electronic multi-player game in an online-type of gaming environment. The star topology can include a number of interfaceable communication devices 1a, 1b, 1c and a central gaming server 22. These devices 1a, 1b, 1c can be game enabled phones being connected via telephone, Bluetooth or short range radio to a central game server device 22. Though not shown in FIG. 3A, each mobile device 1a, 1b and/or 1c may be communicatively connected to one or multiple drones (examples of this without the star topology are shown in FIGS. 4, 5 and 6). Also or alternatively, one or many mobile devices 1a, 1b and/or 1c can be communicatively connected to each drone (again, such drone connections are described further below).

The intercommunications or data exchange(s) between the phones and the server (and thus also between the phones) are identified generally in FIG. 3A, as well as in the following FIGS. 3B, 4 and 5, using the general reference numeral 24. The interfacing devices 1a, 1b, 1c could alternatively be computers and the communication lines 24 could then be via hardwire connections. Also, the intercommunications, whether via phone or computer may be via the internet network, and then the game server 22 is a centralized internet game server. As shown here, the interface devices 1a, 1b, 1c are the game controllers of a video game. The star topology (see FIG. 3A) can provide a single simulation running in one place and the interface devices exchange just the moves of the players or other player specific data and not running the simulation itself. The star topology is often characterized by a single processor running a single game or simulation program. The star topology may thus correspond to a hierarchical structure, wherein the server is the master and the interface devices are clients or slaves.

The actual game logic and an intelligent component may be located in the server 22 to control the game flow and ensure the data exchange 24 between different game partners 1a, 1b, 1c. The server 22 may also control the availability of the participants and the handshaking procedure, when a new gaming partner joins or leaves the game as well as the status of connection of the clients (mobile gaming users). The server 22 may also take over the roles of gaming partners 1a, 1b, 1c in different situations, as for example, when one of the game partners leaves during a game. For this purpose an instance of an artificial intelligence engine of the server 22 can be present and activated automatically. This engine can then play against other game partners 1a, 1b and/or 1c so that they may not be unnecessarily interrupted by the player who has left the game. Note also in many gaming applications, with this sort of networking organization, as is also true for other sorts, see below, it may be that the role of the server may be handed-off to one or more of the mobile communications units 1a, 1b and/or 1c. Thus, in many cases, it may be possible for the server 22 to leave the game, either accidentally or on purpose, leaving control of the game to the mobile communications devices. Certain forms of phone controls without a discreet server are shown and described below.

Thus, shown in FIG. 3B is a generalized representation of one or more other perhaps more preferable usage scenarios, depending upon the computing power and/or memory of the device(s) 1 (e.g., 1a, 1b, and/or 1c) being used. Such networking schemes deal with multi party games either initiated or otherwise maintained (see above) by one (or more) mobile gaming partner(s) using a wireless communication device/server 1a/22 for game data exchange purposes. The wireless interconnection(s) 24 could be either one or more of an ad-hoc network, a limited ad-hoc network or either of a simple RF (radio frequency) interconnection or a BT (Bluetooth) connectivity, or a combination of one or more of the above. Note, as shown in FIG. 3B, all of the phones 1a, 1b and 1c are directly connected together in an interwoven or peer-to-peer fashion; thus, the phone connections may be via telephone or short range radio, or Bluetooth, GPRS (general packet radio service), UMTS (Universal Mobile Telephone Standard), Wireless LAN (Local Area Network), infra red and/or any other communication technology, preferably wireless. Note the drone connectivity is described further below.

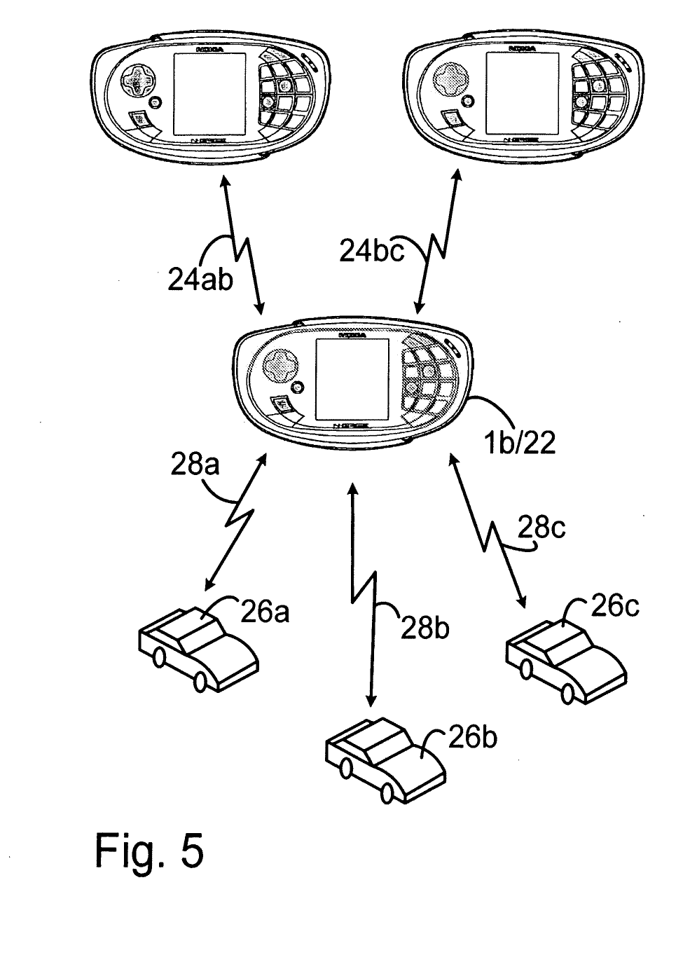

No matter which connectivity means is used for such a gaming party, one of the game partners may then act as a server and control the data exchange between different partners. The gaming device acting as server 1a/22 for such a game (as shown in FIG. 3B, e.g.), may thus play the same role as the network based (centralized) server 22, described in the above paragraphs. It may be noted that any of the devices 1a, 1b, 1c may, on occasion, as seen for example in the indication in FIG. 4 for device 1c/22, or device 1b/22 in FIG. 5, be the master/server, and also that there may be changes in roles of game server and clients (e.g., changing or handing-off the server role from one phone to another); procedures herefor being available and described in other publications thus not being described further here.

FIG. 3B thus shows a conventional interwoven and/or peer-to-peer topology of an electronic multi-player game, as for example, with a number of game-enabled phone devices 1a, 1b, 1c. In difference to the star topology of FIG. 3A, the interwoven structure may be characterized by either a single server or a distributed game program exchanging the moves between the single interface devices. Mixtures of both topologies are also possible, wherein a star topology is extended by star topology sub sections (“Snowflake” structures) or interwoven topology subsections. Alternatively, the interwoven topologies can comprise small star topology sub sections.

FIGS. 4 and 5 show alternative overview embodiments of the invention including schematic representations of a wireless networking of, here, three phones 1a, 1b and 1c with the phones 1c and 1b alternatively acting in these cases as combination phones and servers 1c/22 and 1b/22 in an interwoven topology. Also shown are respective phone intercommunications 24; more specifically including the intercommunication elements 24ab and 24ac in FIG. 4 schematically showing the communications between phone 1a and respective phones 1b and 1c. Similarly shown is the in FIG. 4 is the intercommunication 24bc depicting the intercommunications between phones 1b and 1c. In FIG. 5, the intercommunications shown are 24ab and 24bc, there being no direct communications between phone 1a and 1c, here.

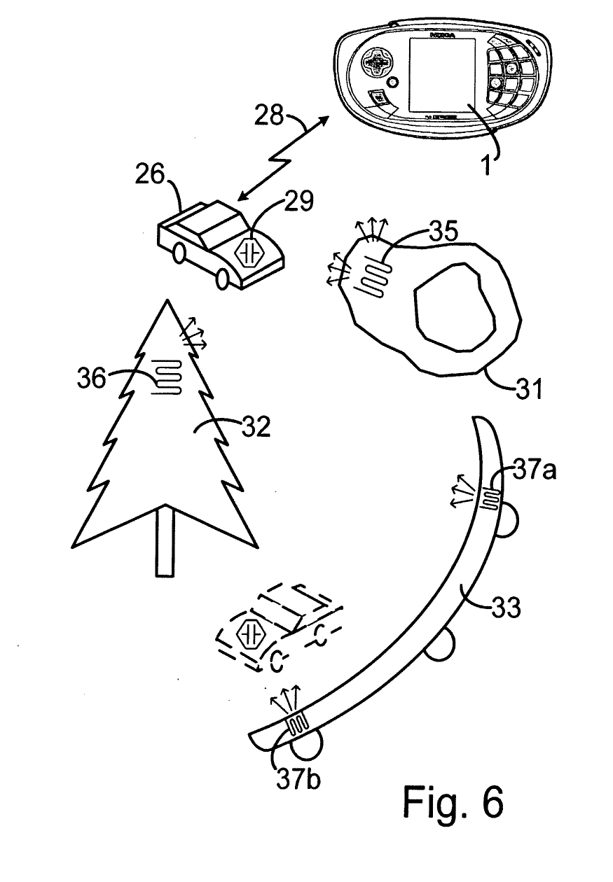

Still further shown in FIGS. 4 and 5 are generally representative remote-controlled devices or drones 26, here shown as cars 26a, 26b and 26c which are interoperative with and/or remotely controlled by respective phones 1a, 1b and 1c. Wireless intercommunications 28; namely 28a, 28b and 28c are also shown as these may be disposed in the FIG. 4 embodiment between the respective phones 1a, 1b, 1c and drones 26a, 26b and 26c. In FIG. 5, these communications 28a, 28b and 28c are shown as between the server phone 1b/22 and the drones 26a, 26b and 26c, the commands being received by the server 1b/22 from the respective phones 1a, 1c and thence being passed to the drones 26a, 26c. Note, the communications 28 may be either one-way control types of commands sent from the phones 1 to the drones 26, or as described below, some embodiments may provide for two-way communications, as for example, when the drones have sensors or other communicative equipment which can sense or otherwise obtain certain features of the game environment and communicate this data back to the phones (see the details of the description relative to FIG. 6 which are completely appropriate in some embodiments generally encompassed by the schematic of FIGS. 4 and 5; thus, the two way arrows 28a, 28b, 28c depicting either one way or two way communications phone to drone and possibly in reverse as well). Moreover, it should also be noted that although drones 26 are shown as cars here, they may be of many alternative device types as will be addressed further below.

The remaining four peer-to-peer connectivity forms (other than the star topology form described above) which are generally shown by the schematics of FIGS. 3B, 4 and 5 further involve connectivity types for communications to the one or more drones. In more details, the ad-hoc network involves the connection of each mobile phone 1 to each other device within range, phone and/or drone (in some cases, only phone to phone, but in other cases, also connected to all drones also). An Application Program Interface (API) would then handle the connectivity completely so that program thinks it is connected to every device (where in some actual embodiments, the message may be routed through the phones, see e.g., FIG. 5). In the limited ad-hoc network, the mobile phones 1 form an ad-hoc network and connect all devices; however, the drones 26 do not generally route anything. In this limited ad-hoc situation, the drones may also or alternatively use some connectionless protocol, as for example Bluetooth LE (also known as BTLE). In the very simple radio frequency protocol using radio broadcasting, all information is sent to every device, and in the Bluetooth connectivity model, the mobile phones 1 are connected with BT (or any other communication technology) and the drones 26 are simple drones receiving and/or sending broadcasts using a very simple RF protocol with broadcasting.

When it comes to the interconnectivity of the drones, in many embodiments, it may be desirable to have the drones be as “dummy” as possible (having minimum communication abilities or needs) thus consuming as little power as possible (by not having the more intricate communication devices on-board). Even so, in some other alternative cases, it may be more desirable to have the drones be even more intelligent than the mobile phones, thus being able to communicate more information or more types, i.e., send and receive and perhaps interpret/process data and/or make decisions thereon. If used, smart game objects (see further descriptions below) may also communicate as remote controlled drones, using some advanced radio protocol(s) and may even have processor(s) or other communication and/or computing capabilities in certain situations.

In an embodiment, using the components of FIGS. 3, 4 and/or 5, it may be noted that at least the server 22 (whether central and separate as in FIG. 3A or disposed on a respective phone 1a, 1b and/or 1c as in FIGS. 3B, 4 and/or 5), alone, or one or more or all of the phones 1 may include the Rules and Game Structure, which in a preferred situation is changeable software disposed inside and/or downloaded into/onto the mobile phones (again, whether onto a server phone only, or distributed to all of the participating phones). The server 22 and/or phones 1 may also include Software controls for the Game Situations, Software to control the remote device(s) (car(s)), and Software to affect by certain rules the movement or other control of the drone depending on optionally includable sensor values, see below.

In a preferred case, as shown for example in either of FIGS. 4 or 5, one phone, here phone 1c/22 in FIG. 4 and 1b/22 in FIG. 5, is the master device, where the other phones 1a and either 1b or 1c are connected thereto, preferably wirelessly, and preferably via Bluetooth or close domain radio (or otherwise as described above), and the master 1c/22 or 1b/22 may handle the main game logistics, running the primary software for the game. However, in the FIG. 4 embodiment, each of the phones 1a, 1b and 1c may be disposed to handle each of their respective devices/drones 26a, 26b and 26c individually, while in the FIG. 5 embodiment, the server 1b/22 may actually deliver the actual commands received first from the respective client phones 1a, 1c. Note again, that in this (or other) networking examples, the server could be any of phones 1a, 1b or 1c or the server responsibilities distributed therebetween, and/or may be handed-off from any one phone to another at any time. In any case, data class definitions for such gaming can then become important as it may be desired to have only certain types of game data being pre-disposed to reach every device, at least every phone 1a, 1b, 1c and the server 22 (whether separate from or operating on/as one (or more) of the phones 1a, 1b, 1c), and perhaps in some embodiments, also the data being disposed to reach every drone 26 as well. Other game data will be preferred to reach only certain, limited devices, as for example, any and all remote control data necessary to provide controls to move one particular remote device 26. Thus in general there may be two classes of data, herein arbitrarily denominated class A and class B; wherein class A may include sensor values and drone control commands and class B data may include game control and game logistics, inter alia. In FIG. 4, the class A data is shown by the communications 24ab, 24ac and 24bc while the class B data is shown by the communications 28a, 28b and 28c. These distinctions are not discreetly shown in FIG. 5.

In a first embodiment, the phones 1 have capacity to control the respective drones in a single or multi-player gaming environment. In a basic case, the phone(s) 1 are operable by a user, as per the keypad inputs 2 (including for example one or more of the keys 7, 8 and/or 9) to send controlling commands wirelessly to the respective drone(s) 26. In the case of the drone being a car 26 (or truck or motorcycle or other type of automobile or like mobile machine, for example) paired with a mobile communication unit 1 as shown in FIG. 4, e.g., driving the car, after ensuring power on for both the car and the mobile communication unit, may be through use of the buttons/keys of the mobile unit or a joystick on the phone, if available, to move the car forward, backward, left or right, or any directional orientation therebetween (particularly if joystick or multi-directional button operated). Speed changes may also be effected by pressing keys/buttons dedicated for such purpose. Instead of using the alphanumeric keys for moving and selecting game pieces/drones, special game keys may, according to other embodiments of the invention, be integrated in the terminal. In some embodiments, the input and output controls, i.e., the I/O system may preferably be programmable.

A game environment could or would also be run by software on the phone/server 1/22 (or a remote server 22) and may establish or have established rules and/or situations generally for competitive (or even non-competitive) play. An initial example may include providing timing and/or course data for one or more players. Such basic play options may be available with any basic sensory effect from the phone (and/or from the drone), as for example, sounds, visible or tactile effects (e.g., bells, whistles or other sounds; lights or text or numerical data; and/or vibration effects, as from vibras, e.g.). Thus, as a first example, the phone(s) 1 may provide a simple timing effect for racing of drones, the timing effect perhaps appearing as audible ticking noises as in a stopwatch or clock, ticking to a pre-set or otherwise adjustable or stoppable endtime, at which point an alarm or buzzer or other noise or visual or tactile effect may appear to indicate completion of the game. Alternatively, the timing or distance or other measurement data can be taken at or by the drone and communicated therefrom to the one or more phones. Other effects could be substituted or run in addition to these in such primary examples.

In further, perhaps more intricate or elaborate examples, one or more of the phone(s) 1 may be adapted to display on each of their respective displays 3 one or more animated representations of the external, remotely-controlled drones 26. As such, animated is defined here as including either simple, immobile, unchanging representations having un-complex features (e.g., line figures), or may be rather elaborate, mobile/moving depictions of the drones (e.g., richly artistically or pictorially rendered), perhaps even showing altering features thereof depending upon the game situations as described further below (see e.g., when a crash occurs).

It may further be noted that the drone representations displayable as described above may be displayable simply on relatively blank backgrounds, or may be more intricately shown in relation to enriched environments. The environments may in simpler embodiments showing mere course or obstacle outlines, e.g. (simple line drawings), or may be more richly engendered (artistically or using pictorial reproductions of true backgrounds). Moreover, in more adapted versions, the backgrounds can be further active as for example being moving, or movable so as to be reflective of motion through an environment existing in a space larger than that portion depicted on the relative display 3 of the phone 1. The environment may have toggle effects for seeing larger or smaller or more or less magnified versions, or toggling to other screens, for information, rules, data updates, or the like. Here also, the sound, visual and/or tactile effects described above may additionally be used to enhance the visual display, and thus enhance the overall sensory impact for the user.

In various embodiments, the game environment may thus be software implemented and controlled and such may be part of the basic game software implemented thereby whether on a discrete server 22, or on a mobile phone server 1/22 or whether distributed on more than a primary mobile phone as e.g., on two or more phones 1a, 1b, and/or 1c (FIGS. 3 and 4, e.g.). In such cases, the environment may thus be controlled by the software itself and/or by one or more of the players who may be able to provide environment control commands to one or more or all drones in a game environment, or to the other phone or phones in the environment through the mobile phone communications network, whatever shape or type that may be.

Still further effects for re-creating a physical environment on and/or within the phone particularly as displayed thereon, and as will be usable with the drones, may be created out of actual physical objects representing barriers, obstacles and/or course definitions, inter alia. Such physical objects may be relatively simple dummy objects representing e.g. rocks or logs, trees or other barriers or obstacles to be set out in actual physical space for defining a course for the drones, e.g., cars 26, to maneuver around during gameplay. Reference to FIG. 6, generally may provide understanding of such aspects.

In FIG. 6, as has been described thusfar, a single phone 1 (here a Nokia® “N-gage”® or Nokia® “N-gage”® “QD”® gamedeck phone) is shown in communication with a drone car 26 via a wireless intercommunication link 28. The single phone set-up also illustrates the potential for solo or individual gameplay. In any case, a rock 31, a tree 32 and a guardrail 33 are shown generally providing obstacles for the car 26 to circumnavigate as directed by the user of the phone 1 communicating therewith via the wireless connection 28. Again, in a first embodiment, these may be dummy objects in that they merely occupy a space that the user has to appreciate through the user's natural senses (e.g., by sight) to avoid, e.g., by moving his drone therearound.

Note, in a further embodiment, the drone 26 may be fitted with a sensor 29 which may be able to sense the presence of a dummy object and may either be made able to communicate this information back to the phone 1 for the user to attempt evasive remote controls, or the sensor may merely be such as to provide indication of state as in distance or time or speed or acceleration (relative to stationary dummy objects) or indications of near misses or perhaps even of contact, as when a drone may collide or crash into an object. The sensors and/or detectors in a remote controlled device may further include relative motion sensors or light sensors or even a camera which together with even mere “dummy objects” (without BT or RFID tags, see below) can be used to create a game environment. Note moreover that in such cases where the drones have one or more sensors, the communication between phone and drone would then be in two directions, back and forth (see the double-headed arrows 28 of FIGS. 4, 5 and 6 which are representative of communications in either one or both directions, phone to drone and/or back). This may also be referred to as bi-directional transmission of data, regardless of data format, which in any nominative case may aid in the enablement of mixed-reality gaming.

Nevertheless, alternatives to dummy objects may be or include objects which are more elaborate and/or are smart objects which may, for example, if made communicative with the phone(s) 1 and/or server 22, further enhance the game-play, providing stimuli for reaction by the player(s) and/or enrich the displayable representation on the phone display(s) 3. Such smart objects may be electrically communicative with the phone(s) using infrared, or Bluetooth, or radio frequency identification (also referred to as RFID) technologies, inter alia (e.g., zigbee or BTLE or the like). Indeed, such smart game objects may also communicate as remote controlled drones, using some advanced BT or radio protocol(s) and may even have a processor or the like as may be desired. Though described in further detail below, it may briefly be noted that relative smart objects, whether physically taking the shape of a particular physical entity (rock, log, tree, guardrail, etc.), or merely being a non-descript object, may in either case have an Bluetooth (BT) or radio frequency (RF) tag, inter alia, disposed therein for used by the phone(s) 1 and/or the drone(s) 26. Note, though either one or both BT and/or RF are described in more detail than other communication means hereinafter does not import any limitative effect thereof on the invention as many wireless means are and will be available and are thus intended to have alternative utility herewith and may thus be included within the scope of the invention herein.

In an example as shown further in FIG. 6, the rock 31 may have a first BT or RF tag 35 disposed thereon/therein, as might the tree 32 have a tag 36, and the guardrail 33 have one or more tags 37, here shown as two tags 37a and 37b. Such BT or RF tags 35, 36 and 37 may then be communicative either to the phone(s) 1 or in a nearer field sense may be made communicative with a sensor or sensors 29 disposed in the drone(s) 26. As such, the sensor(s) 29 may then be Bluetooth and/or RFID reader(s) which may either pick up the Bluetooth signal of a BT tag or generate a radio frequency field that when sufficiently close to an RF tag, then powers up the tag so that the tag can then communicate the data thereof to the reader. In either case, the information from the BT or RFid tag can ultimately then be communicated back to the phone for display of such information to the user for evaluation of appropriate game responsive action.

Note that in the case of smart objects with Bluetooth, RF or other types of communicative tags, the objects, such as the rock 31, tree 32 and guardrail 33 shown in FIG. 5, may yet be objects having fully depicted shapes of their namesakes, or these can be relatively virtual objects having no external resemblance of the object or obstacle(s) they are intended to provide. Then, the read and re-created effect thereof as displayed on the phone will be the only way to determine what the object is. Thus, the ultimate effect of each of the respective BT or RF tags is interpreted by and is controlled by the phone after having the information communicated thereto.

In the case of non-descript BT or RF tags (i.e., tags not disposed in a shape-defined object), the BT or RF tags may be disposed in smart game object cards or beads, e.g., thin cards or beads with the BT or RFID tags incorporated therein or thereon. Such game element cards or beads may include the obstacles described above as well as a plethora of other environmental features, such as gates and/or more elaborate obstacles (e.g. virtual hills, oil slicks) that have different effects on the unfolding of the game. When a drone passes by such a tag, the BT or RFID data is read by the drone's sensor and transmitted to the phone controlling the drone. The game environment is built from these elements and the game is played out in the actual environment.

A yet further alternative may be the use of BT or RFID tags (in the form of collectable cards or beads) to enhance or otherwise change the properties of a single drone, e.g. making it faster or more durable for collisions. The use of RFID cards or beads in this fashion may be like that described for changing phone characteristics or parameters in the Nokia Corp. patent application publication WO2004003829, described briefly above, though the alternative use of BT tags may be substituted therefor as taught and suggested herein.

As mentioned, another alternative is for one or more of the mobile communications devices to be adapted to provide environmental control commands directed to each of one or more drones in a game environment, or directed to one or more other mobile communications devices which are being used to control the one or more drones in the game environment.

As a summary, the disclosed embodiments are directed to creating a game network between one or more phones usually over a close domain radio network (e.g. Bluetooth, WLAN) operating with one or more corresponding external remote controlled peripheral devices called ‘drones’ (e.g. cars or robots, inter alia). The user can then both see the device being controlled or at least a representation of the environment it is moving therethrough on the display screen as well as seeing what the drone sees (or feels) on the user's phone. The drones are remote controlled through user provided inputs via Bluetooth or a close domain radio network (i.e., near field radio) by the phones. The game arena or environment may be built within an actual physical space with either dummy objects or smart game object cards, beads or the like (i.e., thin cards or beads or the like with BT or RFID tags) that create the virtual game space.

These drones may then “play out” the game in the actual space. The governing of the game structure is either distributed between the phones in the network or controlled by a single master phone or other server in the network. The game network provides the structure of the game (goal, rules, score-keeping, penalties, etc.) and drones are active pieces moving in the game area, gathering data with their sensors for the player and for use in the game structure. In some embodiments, the drones can have different sensors to collect data (e.g. acceleration, speed, light (e.g. a camera), sound (e.g., a microphone), BT or RFID reader, magnet switch). Other effects may also be available for the drones (as well as for the phones) including vibras (to provide vibration effects to the drone), and/or speakers (to provide sound effects). Audio-visual processing may then also be performed (either at the drone or at the phone) to enhance the gaming experience. The phones and/or the entire game network can then process the data gathered by the drones and according to the rules of the game, certain data affects the game in certain ways. For instance, within one set of game rules, an actual collision can cause virtual damage that affects the movement of the drone. Within another set of game rules an actual collision may be desirable causing points for the player.

Several different games can be implemented within this framework: miniature or toy car racing, robot wrestling or boxing or other interactive combat-type games, miniature or toy airplane or zeppelin maneuvering or racing, tank or other war machine battling, etc. Note also that either each single player may control a single respective drone (for example: rally game, each player controlling their own car), or multiple players may together control a single drone, as for one example having four (4) players and two (2) tank drones, with a respective two (2) players each controlling a respective tank drone in one game environment. In further embodiments, the control messages of one player can affect several drones, as for example, in a situation when the player controls the game environment itself. Moreover, in certain game situations, the drones do not move, again, an example being a drone which controls or is a part of the environment.

Phone software can be implemented on mobile phones that support e.g. multiple simultaneous Bluetooth or other close field radio or electromagnetic wave connections. However, an API will take care of at least the following: Setting up the game network between the phones, Receiving sensor data from the drone and, Handling data classification: some data is broadcast to all phones in the network, other data only to specific phones. Here also would likely be a protocol which is used for communication between controller (phone) and remote controllable device (e.g. small car). Also there would be APIs to simplify development.

Note, an API (application interface) between the phone and the drone or drones may provide small logistics on the drone side, as for example to control endpoint services such as running the drone engine and/or light, inter alia; as well as to read sensor values through the “listeners” i.e., sensors (e.g., RFID, acceleration, inter alia). The API may also control the moving of data (audio and video stream, file transfer and the like) to and from the drone as well as to and from other phones. Other API functionalities on the phone side may include accessing and controlling the drone and the implementation of different applications. Such an API may also provide the connection logistics, as in providing a continuous observation of network connectivity and maintaining the connectivity, e.g., the disconnections may be automatically reconnected.

The API may also provide an application interface between one or more phones and third party accessories, drones and/or environment pieces. Third party accessory adaptabilities are described hereafter.

As the present invention relates to a remote-controlled uses of phones or like communication devices for drones in game environments, such drones may include toy elements such as toy elements constructable from the Robotics Invention System from LEGO MIND-STORMS® construction sets or assembly kits, a toy product that can be used to create various drone types, vehicles, cars, robots and the like which conventionally can be programmed by means of a computer to perform certain actions, mobile and otherwise. The LEGO MIND-STORMS® Robotics Invention Systems are available from a leading manufacturer, the LEGO Group, which markets under the LEGO® brand name. See LEGO® product information, LEGO MindStorms® Robotics Invention System, April 2001, retrieved from the Internet; see http://mindstorms.lego.com/. Note, in addition to the basic bricks, these LEGO systems offer a microcomputer, an infrared and a radio transmitter, a touch sensor, a light sensor, a rotation sensor, a camera with an USB connection and a built-in microphone, a speaker, electric motors, and batteries.

Thus, the disclosed embodiments are usable with drones which may either be pre-constructed or which may be constructed by the user in any of various shapes and/or types from construction sets which may include one or more block components; the block components each having a main block section having a head portion forming a protrusion or stud portion projecting out of the main block section, and a second end portion of a base including an indentation or coupling socket recessed into the second face of the main block section, wherein the indentation is complimentary in shape with respect to the protrusion. Then, the user can use such blocks to build robotic or automobile drone products and then use the computer program on their phone 1 to control the constructed robotic or automobile drone product. That phone 1 with the computer program may then be used to control the movement within the robotic or automobile drone device. The LEGO® assembly kits enable the building of either simple drones or rather complex mechanical structures and include various electronic components to control, for example, remote-controlled vehicles (LEGO® Racers) and PC-controlled robots (Lego's Robotics Invention System, and Spybotics), inter alia.

The mobile phones 1 described herein could offer, not only substantially the same technologies for controlling the LEGO® robotic systems, but also many other mobile technologies that could be utilized with such LEGO® toys. These additional technologies may be such as those described hereinabove including, for example: movement sensors, vibras, cameras, speakers, microphones, audio-visual processing, DSP, application uploads, and BlueTooth (BT) connectivities. These may thus be particularly useful in games according hereto mixing LEGO® toys and a video game controllable by the phone or phones 1. The offering of many technologies together can thus make new game concepts possible and enrich the game play.

More specific application of the mobile technologies described hereinabove and their usage cases with LEGO-type toy drones could include the following, inter alia:
BlueTooth (BT): Use of BT for the data transmission between a toy drone and a phone control unit, for example, to steer a vehicle, or instruct a robot. The transmission could be bi-directional, as in “force feedback,” i.e., forces “felt” in the phone as communicated data, e.g., a crash, from the drone. BT could also be used to enable proximity detection, for example, in a robot fighting.
Movement sensors: Movement sensors may be used to sense, for example, a car hitting a wall, or a robot having been shot, to enable force feedback in the phone control unit, for example, activating the phone's vibras to simulate at/on the phone a vibrational contact thereby felt by the phone user. A gesture recognition engine, as may be available from the Nokia Company could be used to control, for example, a robot's hand movements, etc.
Vibras: Vibrations of the phone control unit making, for example, the steering of a car or a robot more difficult due to having been crashed to a wall or having been shot. Alternatively, the vibras of the phone can be incorporated into the toy drone when/if the phone is integrated into the toy (see below) to create a vibrational effect in the toy.
Camera: A camera could be used for delivering an in-car view to the phone, for example, for racing or a robot-eye view, for example, for shooting. Further, a camera with computer vision technology could be used to enable a robot to recognize objects, for example, to avoid barriers, or to grip onto objects.
Integrated Hands-Free (IHF) speaker and microphone: Reproduction of speech and audio. Recording of audio.
Audio processing: Creation of audio effects to simulate, for example, a car engine or to morph speech in/from a robot.

Thus, such technologies can be used at the phones to enhance the game playing experience for the player based upon data transmitted from the toy drones to the phone. Or, these technologies could also or alternatively be incorporated into the toy drones themselves to create those effects at the drones themselves, also heightening the simulation reality.

As a further alternative, the phone control units 1 hereof may include covering structures having complimentary projections and coupling sockets which are operative with the building blocks of the LEGO-type building/construction sets. The covering structures may either be substantially permanent parts of the phone units 1 or may be replaceable/interchangeable covers (e.g., front and/or back covers) such as are otherwise (e.g., without the projections/sockets) commercially available for certain Nokia phone models, inter alia.

In such alternatives then the phones themselves may be built into particular drones thereby bringing the communication and other effects directly to the drone via the built-in phone. Then, a separate control unit, e.g., another phone 1 (or a PC, or other wireless controller could be used as the control unit) would be used to control the drone in the ways described above. The BT, movement sensor(s), vibra, camera, IHF and the like, of the now built-in phone can then be brought to the drone. For example, the communication can be by the BT; the vibra can vibrate the drone; the camera can communicate images (stills or motion) back to the control phone and so on to heighten the reality simulation of the drone. Similarly, the built-in phone may now provide power for electric drone motors (power supply and/or control) via its battery now also built into the drone.

In summary, an active cover with embedded Lego joints (cooperative projections and/or sockets) could turn a phone into an integral part of a Lego toy, for example of a vehicle or a robot, and provide such Lego toys with many advanced technologies, thus also offering the possibility of using such technologies together with the drones to enable new, mixed-reality game concepts with Lego toys.

Other, different mobile robot or like drone platforms exist which could also be applicable herewith, these spanning a wide range of costs and capabilities, from robots with electronic packages for specialized operations to inexpensive remote control cars and robots for educational applications. Remote control toy cars such as those manufactured by toymakers are inexpensive remotely driven vehicles which may be driven by the Bluetooth radio controlled phones (via the control buttons or joysticks thereof) described herein. Examples are those remote control cars manufactured by Tyco of Mattel, Inc. and other remote control toy car manufacturers. At the other extreme are more expensive robotic vehicles. For example, robotic vehicles available from Real World Incorporated (RWI) are capable of remote control via a joystick and also capable of being programmed to perform autonomous navigation. The Koala robot available from K-Team is a six-wheeled mid-sized robot capable of communication, sensing, and all-terrain operation. These are highly capable robotic vehicles which also could be used herein.

1. A method for gaming using a mobile communication: device and a remotely-controllable drone, the mobile communication device being adapted to remotely-control the remotely-controllable drone; the method comprising:
providing game control software to the mobile communication device, the game control software including rules for play affecting the operation of the remotely-controllable drone; and,
operating the remotely-controllable drone using the mobile communication device with remote control within the rules of play of the game.

2. A method according to claim 1 wherein the game control software provides one of sensory or measurement data feedback to the user of the mobile communication device.

3. A method according to claim 2 wherein the sensory or measurement data feedback is one of auditory, visual or tactile feedback.

4. A method according to claim 2 wherein the sensory or measurement data feedback is sensed at one of the mobile communication device or the remotely-controllable drone.

5. A method according to claim 2 wherein the sensory or measurement data feedback is derived from one or both of the operation of the remotely-controllable drone and the rules for play.

6. A method according to claim 1 wherein the sensory or measurement data is involved in bi-directional transmission of data that enables mixed-reality gaming.

7. A method according to claim 1 further including providing a game environment in which the remotely-controllable drone is operated.

8. A method according to claim 7 wherein the environment includes objects about which the remotely-controllable drone is movable.

9. A method according to claim 8 wherein the objects are dummy objects.

10. A method according to claim 8 wherein the environment includes the virtual surroundings in which the remotely-controllable drone is movable.

11. A method according to claim 8 wherein the objects are smart objects.

12. A method according to claim 11 wherein the smart objects are non-descript of the objects they represent.

13. A method according to claim 11 wherein the smart objects are re-programmable.

14. A method according to claim 11 wherein the smart objects are communicative to one or both of the mobile communication device and the remotely-controllable drone.

15. A method according to claim 14 wherein the smart objects are communicative via one or more of infrared, Bluetooth or radio frequency technologies.

16. A method according to claim 11 wherein the smart objects each include a respective one of a Bluetooth (BT) or radio frequency (RF) tag.

17. A method according to claim 1 wherein either or both of the mobile communication device and the remotely-controllable drone has a sensor for sensing the operating environment.

18. A method according to claim 17 wherein the remotely-controllable drone has a sensor and a means for communicating sensed data to the mobile communication device.

19. A method according to claim 17 wherein the remotely-controllable drone has a sensor for sensing dummy objects in the environment.

20. A method according to claim 17 wherein the remotely-controllable drone has a sensor for sensing smart objects in the environment.

21. A method according to claim 20 wherein the remotely-controllable drone has one of a BT or an RF reader for reading BT or RF data from BT or RF tag smart objects in the environment.

22. A method according to claim 17 wherein the mobile communication device provides sensory data to the user derived from the sensed data.

23. A method according to claim 22 wherein the sensory data is visually depicted on a display of the mobile communication device.

24. A method according to claim 1 including a sensor for one of movement, vibration, speed, acceleration, visual or audio data.

25. A method according to claim 24 wherein the sensor is one of a camera and a microphone.

26. A method according claim 1 further including one or more additional mobile communication devices operative within the rules of play of the game.

27. A method according to claim 26 wherein one or more of the one or more additional mobile communication devices is communicative with the drone.

28. A method according to claim 27 wherein the one or more additional mobile communication devices are communicative with the drone to one of provide command signals thereto or receive feedback therefrom.

29. A method according to claim 26 further including one or more corresponding additional remotely-controllable drones to create a multi-player gaming environment.

30. A method according to claim 29 wherein each of the additional mobile communication devices separately operates each of the corresponding additional remotely-controllable drones in the gaming environment.

31. A method according to claim 24 further including a network of intercommunications between all of the mobile communication devices.

32. A method according to claim 24 further including a game server.

33. A method according to claim 32 wherein the game server is one of the mobile communication devices.

34. A method according to claim 32 wherein the game server is distributed over a plurality of the mobile communication devices.

35. A method according to claim 1 wherein the drone is one of a mobile and a non-mobile device.

36. A method according to claim 35 wherein the drone is mobile and the game includes at least one of a race and an obstacle course.

37. A method according to claim 1 wherein the drone is user-constructable from a set of interlocking blocks.

38. A method according to claim 37 further including a communication unit having a cover including one or more projections or sockets cooperative with the interlocking blocks of the set of interlocking blocks to allow for incorporation of the communication unit into the drone.

39. A computer program for carrying out the method of claim 1.

40. A mobile communication device comprising a game application for operating a remotely-controllable drone in accordance with the method of claim 1.

41. A gaming set including:
at least one mobile communication device according to claim 40;
at least one remotely-controllable drone operable by said wireless device;
and a gaming environment.

42. A mobile communication device adapted to be used for gaming with a remotely-controllable drone, the mobile communication device being adapted to remotely-control the remotely-controllable drone; the mobile communication device comprising:
game control software disposed within the mobile communication device, the game control software including rules for play affecting the operation of the remotely-controllable drone; and,
remote control hardware and software disposed within the mobile communication device for operating the remotely-controllable drone within the rules of play of the game.

43. A mobile communication device according to claim 42 wherein the game control software provides sensory feedback to the user of the mobile communication device.

44. A mobile communication device according to claim 43 wherein the sensory feedback is one of auditory, visual or tactile feedback.

45. A mobile communication device according to claim 42 further including hardware for receiving sensory feedback from a drone.

46. A mobile communication device according to claim 45 wherein the sensory feedback is generated by one or more smart objects which are communicative to one or both of the mobile communication device and the remotely-controllable drone.

47. A mobile communication device according to claim 46 wherein the smart objects are communicative via one or more of infrared, Bluetooth or radio frequency technologies.

48. A mobile communication device according to claim 42 wherein either or both of the mobile communication device and the remotely-controllable drone has a sensor for sensing the operating environment.

49. A mobile communication device according to claim 42 wherein the mobile communication device provides sensory data to the user derived from the sensed data.

50. A mobile communication device according to claim 49 wherein the sensory data is visually depicted on a display of the mobile communication device.

51. A mobile communication device according to claim 49 wherein the sensory data is vibrationally depicted on the mobile communication device.

52. A mobile communication device according to claim 42, the mobile communication device further including hardware for communicating with one or more additional mobile communication devices operative within the rules of play of the game.

53. A mobile communication device according to claim 42 wherein the drone is user-constructable from a set of interlocking blocks.

54. A mobile communication device according to claim 53 further including a communication unit having a cover including one or more projections or sockets cooperative with the interlocking blocks of the set of interlocking blocks to allow for incorporation of the communication unit into the drone.

55. A system for mobile gaming with a peripheral drone, the system comprising:
a peripheral drone, and
a mobile communication device adapted to be used for communicating with the peripheral drone, the mobile communication device being adapted to remotely-control the peripheral drone in a game environment; the mobile communication device comprising:
game control software disposed within the mobile communication device, the game control software including rules for play affecting the operation of the remotely-controllable drone; and,
remote control hardware and software disposed within the mobile communication device for operating the remotely-controllable drone within the rules of play of the game.

56. A system according to claim 55 wherein the drone is one of a mobile and a non-mobile device.

57. A system according to claim 55 wherein the drone is mobile and the game includes at least one of a race and an obstacle course.

58. A system according to claim 55 wherein the drone is user-constructable from a set of interlocking blocks.

59. A system according to claim 58 further including a communication unit having a cover including one or more projections or sockets cooperative with the interlocking blocks of the set of interlocking blocks to allow for incorporation of the communication unit into the drone.

60. A system according claim 55 further including one or more additional mobile communication devices operative in the within the rules of play of the game.

61. A system according to claim 60 wherein one or more of the one or more additional mobile communication devices is communicative with the drone.

62. A system according to claim 61 wherein the one or more additional mobile communication devices are communicative with the drone to one of provide command signals thereto or receive feedback therefrom.

63. A system according to claim 55 further including one or more corresponding additional remotely-controllable drones to create a multi-player gaming environment.

64. A system according to claim 63 wherein each of the additional mobile communication devices separately operates each of the corresponding additional remotely-controllable drones in the gaming environment.

65. A system according to claim 55 further including a network of intercommunications between all of the mobile communication devices.

66. A system according to claim 55 further including a game server.

67. A system according to claim 66 wherein the game server is one of the mobile communication devices.

68. A system according to claim 66 wherein the game server is distributed over a plurality of the mobile communication devices.

69. Program software for mobile gaming using a mobile communication device and a remotely-controllable drone, the mobile communication device being adapted to remotely-control the remotely-controllable drone; the program software comprising:
game control software adapted to run in connection with the mobile communication device, the game control software including rules for play affecting the operation of the remotely-controllable drone; and,
communication software adapted to control operation of the remotely-controllable drone using the mobile communication device with remote control within the rules of play of the game.

70. A software carrier for holding software according to claim 69.

71. A server running software according to claim 69.
